(19) United States
(12) Patent Application Publication
(10) Pub. No.: US 2026/0216903 A1
(43) Pub. Date: Jul. 30, 2026

(54) ROBOT

(71) Applicant: KAWASAKI JUKOGYO KABUSHIKI KAISHA, Kobe-shi, Hyogo (JP)

(72) Inventors: Nobuhiro DEMURA, Kobe-shi (JP); Takashi ARAKI, Kobe-shi (JP); Taishi MASUI, Kobe-shi (JP); Ryo TANIUCHI, Kobe-shi (JP)

(73) Assignee: KAWASAKI JUKOGYO KABUSHIKI KAISHA, Kobe-shi, Hyogo (JP)

(21) Appl. No.: 19/149,994

(22) PCT Filed: Feb. 5, 2024
(86) PCT No.: PCT/JP2024/003737

§ 371 Date: Jul. 22, 2025

(30) Foreign Application Priority Data
Feb. 20, 2023 (JP) 2023-024153

(51) Int. Cl. B25J 19/00; B25J 9/10

(52) U.S. Cl. CPC B25J 19/0075; B25J 9/101; B25J 19/0091

(57) ABSTRACT

A robot (100) includes a restrictor (52) to restrict relative movement between a first member (22) and a second member (21), a buffer (62) between a first portion (22a) and a second portion (21b), and a cover (72) to cover the buffer (62).

### TECHNICAL FIELD

The present disclosure relates to a robot.

### BACKGROUND ART

Conventionally, a robot including a buffer is known. Japanese Patent Laid-Open No. 2019-076975 discloses a robot including a base, a first arm, and a second arm.

The first arm rotates relative to the base. The first arm and the second arm rotate relative to each other. A protrusion protruding in a direction away from the rotation axis of the first arm is provided on the first arm. An elastic member is disposed on the protrusion to assist a braking force for stopping rotation of the first arm relative to the base. The elastic member is rubber. A restrictor is disposed on the base. The restrictor protrudes in the direction away from the rotation axis of the first arm. As the first arm rotates, the elastic member is sandwiched between the protrusion of the first arm and the restrictor of the base.

### PRIOR ART

### Patent Document

Patent Document 1: Japanese Patent Laid-Open No. 2019-076975

### SUMMARY OF THE INVENTION

However, in Japanese Patent Laid-Open No. 2019-076975, the elastic member is rubber, and thus when the first arm rotates, the elastic member sandwiched between the protrusion of the first arm and the restrictor of the base is crushed. Consequently, fragments of the elastic member acting as a buffer are scattered. Therefore, a robot that can reduce or prevent scattering of fragments of the buffer is desired.

The present disclosure is intended to solve the above problem. The present disclosure aims to provide a robot capable of reducing or preventing scattering of fragments of a buffer.

A robot according to an aspect of the present disclosure includes a first member, a second member configured to move relative to the first member, a restrictor including a first portion that is a portion of the first member and a second portion that is a portion of the second member to restrict relative movement between the first member and the second member, a buffer on at least one of the first member and the second member and between the first portion and the second portion, and a cover on at least one of the first member and the second member to cover the buffer.

As described above, the robot according to this aspect of the present disclosure includes the cover disposed to cover the buffer. Accordingly, even when the buffer disposed between the first portion and the second portion is deformed and fragments are generated when the first portion and the second portion approach each other, the fragments are covered with the cover such that scattering of the fragments of the buffer can be reduced or prevented.

According to the present disclosure, it is possible to reduce or prevent scattering of the fragments of the buffer.

### BRIEF DESCRIPTION OF THE DRAWINGS

FIG. 1 is a diagram showing a robot according to an embodiment.

FIG. 2 is a block diagram of the robot and a control device according to the embodiment.

FIG. 3 is a diagram showing a buffer and a cover disposed on a base according to the embodiment.

FIG. 4 is a diagram showing the buffer and the cover disposed on the base, and a buffer and a cover disposed on a portion of a first arm on the rotating base side according to the embodiment.

FIG. 5 is a diagram showing the buffer and the cover disposed on the portion of the first arm on the rotating base side according to the embodiment.

FIG. 6 is a diagram showing a buffer and a cover disposed on a portion of the first arm on the second arm side according to the embodiment.

FIG. 7 is an enlarged view showing the buffer and the cover disposed on the portion of the first arm on the rotating base side according to the embodiment.

FIG. 8 is a diagram showing the buffer with the cover removed.

FIG. 9 is a diagram showing the cover according to the embodiment.

FIG. 10 is a diagram showing the cover shown in FIG. 9 as viewed from a different angle.

FIG. 11 is a diagram showing a cover disposed on a rotating base and a buffer disposed on a first arm according to a modified example.

### MODES FOR CARRYING OUT THE INVENTION

An embodiment embodying the present disclosure is hereinafter described on the basis of the drawings. In the following description, an upward-downward direction is defined as a Z direction, and the upper and lower sides are defined as a Z1 side and a Z2 side, respectively. A direction perpendicular to the Z direction is defined as an X direction. A first side in the X direction is defined as an X1 side, and a second side in the X direction is defined as an X2 side. A direction perpendicular to the Z direction and the X direction is defined as a Y direction. A first side in the Y direction is defined as a Y1 side, and a second side in the Y direction is defined as a Y2 side.

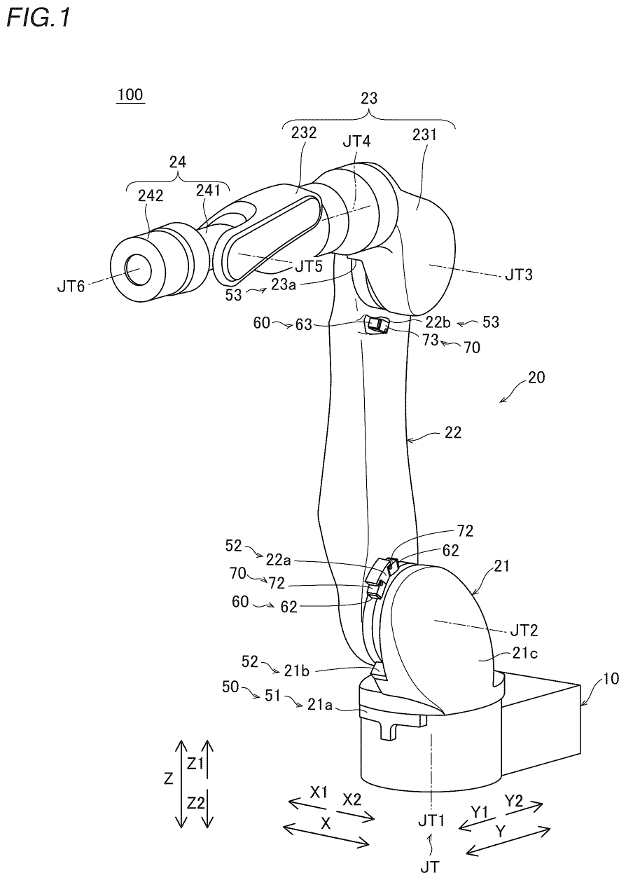

As shown in FIG. 1, a robot 100 is a vertical articulated robot. The robot 100 includes a base 10 and a robot arm 20 attached to the base 10. An end effector is attached to a distal end of the robot arm 20. The base 10 is an example of a first member.

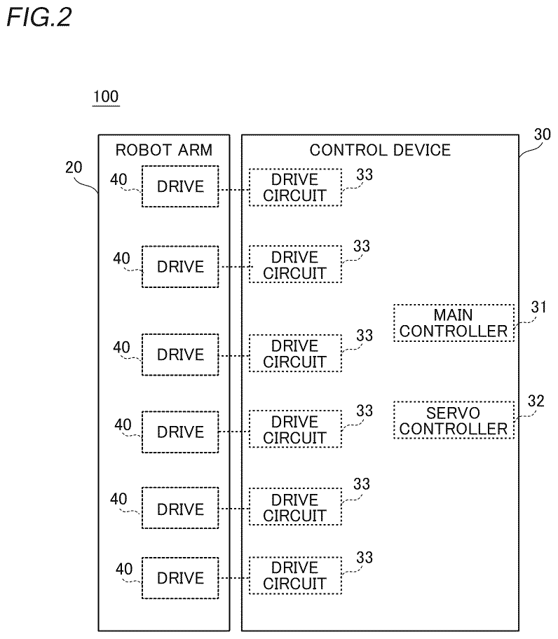

The robot 100 includes a plurality of joint axes JT. For example, the robot arm 20 includes six joint axes JT1, JT2, JT3, JT4, JT5, and JT6. That is, the robot arm 20 is a 6-axis vertical articulated robot. The number of joint axes JT may be other than six. In addition, a drive 40 shown in FIG. 2 is disposed in each of the joint axes JT1 to JT6.

The robot arm 20 includes a rotating base 21, a first arm 22, a second arm 23, and a wrist 24. The base 10 and the rotating base 21 are connected to each other by the joint axis JT1. The joint axis JT1 is aligned along the Z direction. The rotating base 21 and the first arm 22 are connected to each other by the joint axis JT2. The joint axis JT2 is aligned along a horizontal direction. The first arm 22 and the second arm 23 rotate relative to each other. The first arm 22 and the second arm 23 are connected to each other by the joint axis JT3. The joint axis JT3 is aligned along the horizontal direction. Specifically, the second arm 23 includes a link 231 and a link 232. The link 231 is connected to the first arm 22. The link 231 and the link 232 are connected to each other by the joint axis JT4. The joint axis JT4 is aligned along a direction perpendicular to the joint axis JT3. The link 232 of the second arm 23 and the wrist 24 are connected to each other by the joint axis JT5. Specifically, the wrist 24 includes a first member 241 and a second member 242. The first member 241 is connected to the second arm 23. The first member 241 and the second member 242 are connected to each other by the joint axis JT6. The joint axis JT6 is aligned along a direction perpendicular to the joint axis JT5. The rotating base 21 is an example of a second member. The first arm 22 is an example of a first member or an arm. The second arm 23 is an example of a second member.

As shown in FIG. 2, the robot 100 is connected to a control device 30. The control device 30 includes a main controller 31, a servo controller 32, and drive circuits 33. The main controller 31 and the servo controller 32 include a central processing unit (CPU), for example. The main controller 31 controls the joint axes JT of the robot 100. The servo controller 32 controls power supplied to the drives 40 of the joint axes JT based on a command from the main controller 31.

The drive circuits 33 supply drive power to the drives 40 of the joint axes JT. The drive circuits 33 include inverter circuits that supply AC power to the drives 40. A drive circuit 33 is provided for each joint axis JT.

The drives 40 serve as drive sources to operate the robot 100. The drives 40 include servomotors, encoders, and speed reducers. The servomotors rotate when power is supplied thereto. Rotation shafts of the servomotors rotate by three-phase AC power, for example. The encoders detect the rotation angles of the servomotors. The encoders then output detection values indicating the detected rotation angles of the servomotors to the main controller 31 and the servo controller 32.

In this embodiment, as shown in FIG. 1, the robot 100 includes a restrictor 50, a buffer 60, and a cover 70. The restrictor 50 includes a first restrictor 51, a second restrictor 52, and a third restrictor 53. The first restrictor 51, the second restrictor 52, and the third restrictor 53 are examples of a restrictor.

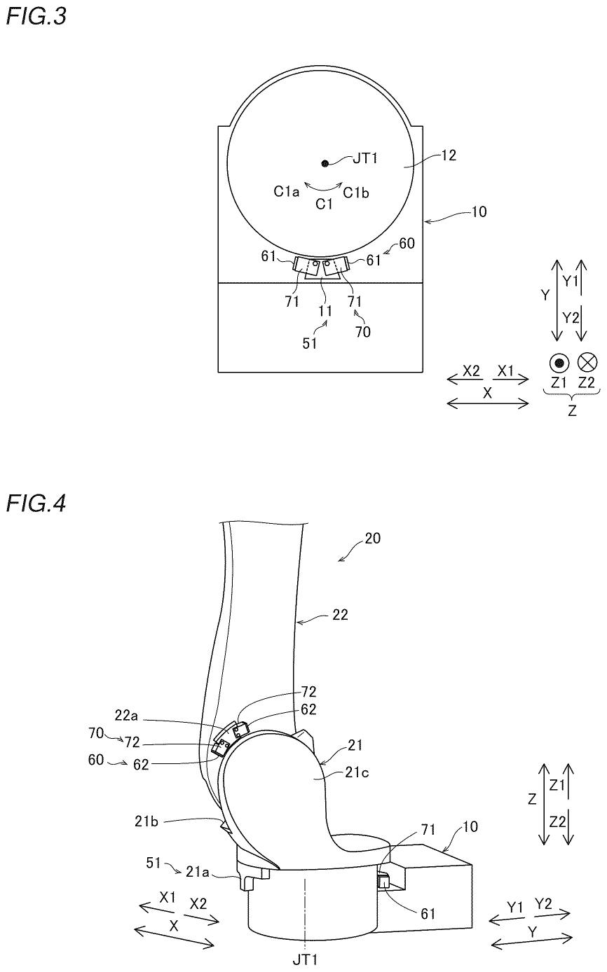

The first restrictor 51 includes a protrusion 11 that is a portion of the base 10 shown in FIG. 3 and a protrusion 21a that is a portion of the rotating base 21 shown in FIG. 4, and restricts relative movement between the base 10 and the rotating base 21. As shown in FIG. 3, the protrusion 11 is fixed to the base 10. Specifically, the base 10 includes a placement portion 12 on which the rotating base 21 is placed. The placement portion 12 has a disk shape as viewed from the Z1 side. The protrusion 11 is disposed in the vicinity of the outer edge of the placement portion 12. The protrusion 11 protrudes to the Z1 side. As shown in FIG. 4, the position of the protrusion 21a on the rotating base 21 can be changed. The protrusion 21a is disposed on the outer periphery of the rotating base 21. The position of the protrusion 21a on the outer periphery of the rotating base 21 can be changed around the joint axis JT1. The protrusion 21a protrudes to the Z2 side on the outer periphery of the rotating base 21. When the rotating base 21 rotates excessively around the joint axis JT1, the protrusion 11 of the base 10 contacts the protrusion 21a of the rotating base 21. The protrusion 11 is an example of a first portion. The protrusion 21a is an example of a second portion.

As shown in FIG. 5, the second restrictor 52 includes a protrusion 21b that is a portion of the rotating base 21 and a protrusion 22a that is a portion of the first arm 22, and restricts relative movement between the rotating base 21 and the first arm 22. Specifically, the rotating base 21 includes a mount 21c to which the first arm 22 is attached. The mount 21c is disposed along a Z1 direction.

The protrusion 21b is disposed on the mount 21c. The protrusion 21b protrudes from the mount 21c to the X1 side. The protrusion 21b is also disposed on the Y2 side of the mount 21c. The protrusion 22a is disposed on the side surface of the first arm 22 on the X2 side. The protrusion 22a protrudes from the first arm 22 to the X2 side. When the first arm 22 rotates excessively around the joint axis JT2, the protrusion 22a of the first arm 22 contacts the protrusion 21b of the rotating base 21. The protrusion 21b is an example of a second portion, and the protrusion 22a is an example of a first portion.

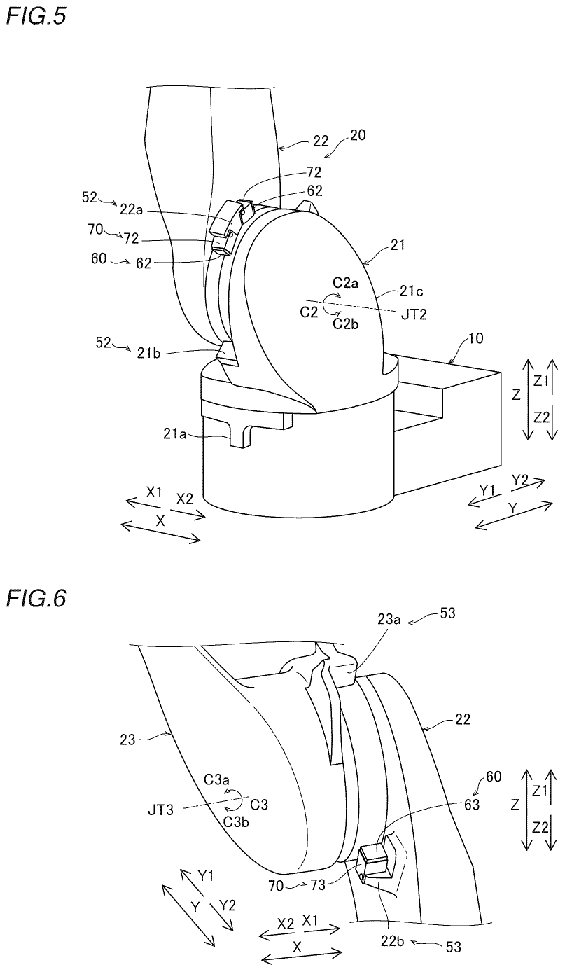

As shown in FIG. 6, the third restrictor 53 includes a protrusion 22b that is a portion of the first arm 22 and a protrusion 23a that is a portion of the second arm 23, and restricts relative movement between the first arm 22 and the second arm 23. Specifically, the protrusion 22b is disposed on the side surface of the first arm 22 on the X2 side. The protrusion 22b protrudes from the first arm 22 to the X2 side. The protrusion 23a protrudes from the second arm 23 to the X1 side. As shown in FIG. 1, the protrusion 22b and the protrusion 23a are also disposed on the Y1 side of the robot 100. When the first arm 22 and the second arm 23 rotate excessively relative to each other around the joint axis JT3, the protrusion 22b of the first arm 22 and the protrusion 23a of the first arm 22 contact each other. The protrusion 22b is an example of a first portion. The protrusion 23a is an example of a second portion.

The buffer 60 includes a first buffer 61, a second buffer 62, and a third buffer 63. As shown in FIG. 4, the first buffer 61 is disposed on the base 10 and between the protrusion 11 of the base 10 and the protrusion 21a of the rotating base 21. Specifically, as shown in FIG. 3, the first buffer 61 is disposed on both the C1a side and the C1b side of the protrusion 11. The C1a side and the C1b side refer to a first side and a second side in a C1 direction, which is a rotation direction around the joint axis JT1, respectively. The first buffer 61, the second buffer 62, and the third buffer 63 are examples of a buffer.

As shown in FIG. 5, the second buffer 62 is disposed on the first arm 22 and between the protrusion 21b of the rotating base 21 and the protrusion 22a of the first arm 22. Specifically, the second buffer 62 is disposed on both the C2a side and the C2b side of the protrusion 22a. The C2a side and the C2b side refer to a first side and a second side in a C2 direction, which is a rotation direction around the joint axis JT2, respectively.

As shown in FIG. 6, the third buffer 63 is disposed on the first arm 22 and between the protrusion 22b of the first arm 22 and the protrusion 23a of the second arm 23. Specifically, the third buffer 63 is disposed on the protrusion 22b on the side on which the third buffer 63 comes into contact with the protrusion 23a of the second arm 23. The third buffer 63 shown in FIG. 6 is disposed on the C3a side of the protrusion 22b. The third buffer 63 shown in FIG. 1 is disposed on the C3b side of the protrusion 22b. The C3a side and the C3b side refer to a first side and a second side in a C3 direction, which is a rotation direction around the joint axis JT3, respectively.

The cover 70 includes a first cover 71, a second cover 72, and a third cover 73. As shown in FIG. 3, the first cover 71 is disposed on the base 10 so as to cover the first buffer 61. The first cover 71 is disposed on the protrusion 11 of the base 10. As shown in FIG. 5, the second cover 72 is disposed on the first arm 22 so as to cover the second buffer 62. The second cover 72 is disposed on the protrusion 22a of the first arm 22. As shown in FIG. 1 and FIG. 6, the third cover 73 is disposed on the first arm 22 so as to cover the third buffer 63. The third cover 73 is disposed on the protrusion 22b. The first buffer 61, the second buffer 62, and the third buffer 63 have the same or similar configurations. The first cover 71, the second cover 72, and the third cover 73 have the same or similar configurations. Therefore, the second buffer 62 and the second cover 72 are described below. The first cover 71, the second cover 72, and the third cover 73 are examples of a cover.

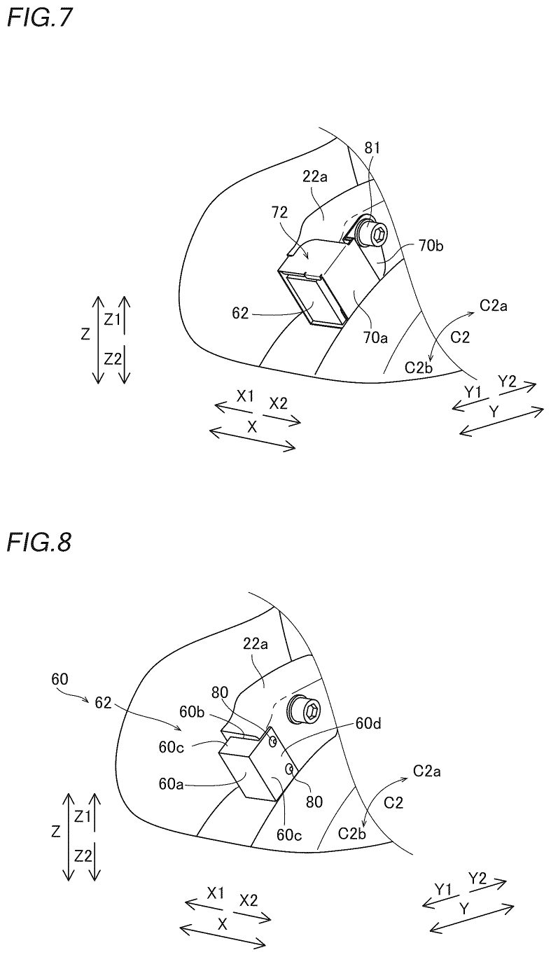

In this embodiment, as shown in FIG. 7, when the protrusion 21b of the rotating base 21 and the protrusion 22a of the first arm 22 approach each other, the second cover 72 surrounds and covers a portion of the second buffer 62 other than a portion facing the protrusion 21b. Specifically, as shown in FIG. 8, the buffer 60 has a rectangular parallelepiped shape. The second buffer 62 includes a first surface 60a, a second surface 60b, and third surfaces 60c. The first surface 60a is a surface that comes into contact with the protrusion 21b of the rotating base 21. The second surface 60b is a surface that is disposed on the side opposite to the first surface 60a in the C2 direction, which is a relative movement direction between the rotating base 21 and the first arm 22. The third surfaces 60c are surfaces that connect the first surface 60a to the second surface 60b. Four third surfaces 60c are disposed so as to connect the first surface 60a to the second surface 60b. The second buffer 62 also includes a mount 60d. The mount 60d is disposed along a surface of the protrusion 22a of the first arm 22. The mount 60d is fastened to the protrusion 22a of the first arm 22 by threaded portions 80 such as screws such that the second buffer 62 is fixed to the protrusion 22a.

In this embodiment, as shown in FIG. 7, the second cover 72 includes a surrounding portion 70a. The surrounding portion 70a surrounds and covers the third surfaces 60c of the second buffer 62. Specifically, the surrounding portion 70a surrounds and covers the entire peripheries of the third surfaces 60c of the second buffer 62. The surrounding portion 70a surrounds the four third surfaces 60c. The surrounding portion 70a has a frame shape so as to surround the four third surfaces 60c.

In this embodiment, the surrounding portion 70a does not cover all of the third surfaces 60c of the second buffer 62 in the C2 direction, which is the relative movement direction between the rotating base 21 and the first arm 22, but covers more than half of the third surfaces 60c of the second buffer 62. Thus, the second buffer 62 protrudes to the C2b side more than the second cover 72.

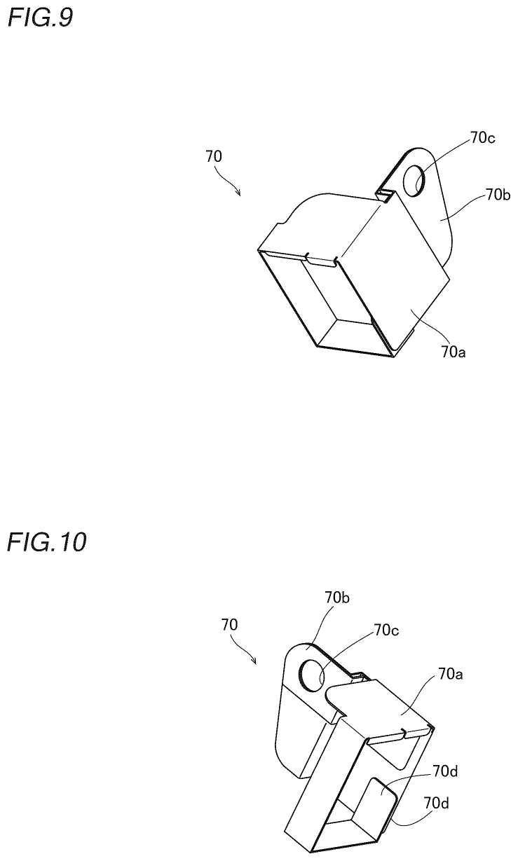

In this embodiment, the second cover 72 includes a mount 70b. The mount 70b is attached to the first arm 22. The mount 70b is disposed along the protrusion 22a of the first arm 22. As shown in FIG. 9, a hole 70c is formed in the mount 70b. As shown in FIG. 7, a threaded portion 81 such as a screw inserted into the hole 70c is fastened to the protrusion 22a of the first arm 22 such that the second cover 72 is fixed to the protrusion 22a.

In this embodiment, the second buffer 62 includes a rubber member or a resin member. The second cover 72 includes a sheet metal member. The cover 70 includes a folded sheet metal member. The surrounding portion 70a of the second cover 72 is folded so as to surround the four third surfaces 60c. As shown in FIG. 10, ends 70d of the surrounding portion 70a folded so as to surround the four third surfaces 60c are not fixed to each other. The surrounding portion 70a and the mount 70b are integrally formed of a sheet metal member. The cover 70 may include a plurality of members, such as a member including a portion of the surrounding portion 70a and the mount 70b, and a member including the remaining portion of the surrounding portion 70a.

### Advantages of This Embodiment

The robot 100 includes the second cover 72 to cover the second buffer 62. Accordingly, even when the buffer 60 disposed between the protrusion 22a and the protrusion 21b is deformed and fragments are generated when the protrusion 22a and the protrusion 21b approach each other, the fragments are covered with the second cover 72 such that scattering of the fragments of the buffer 62 can be reduced or prevented. The first cover 71 and the third cover 73 also have the same advantage.

The second cover 72 is configured to surround and cover the portion of the second buffer 62 other than the portion facing the protrusion 21b when the protrusion 21b of the rotating base 21 and the protrusion 22a of the first arm 22 approach each other. Accordingly, a portion of the second buffer 62 is exposed, and thus it is easy to visually check whether or not the second buffer 62 has deteriorated.

The second buffer 62 includes the first surface 60a contacting the second restrictor 52, the second surface 60b on the side opposite to the first surface 60a in the relative movement direction between the first arm 22 and the rotating base 21, and the third surfaces 60c connecting the first surface 60a to the second surface 60b. The second cover 72 includes the surrounding portion 70a to surround and cover the third surfaces 60c of the second buffer 62. When the protrusion 21b of the rotating base 21 contacts the second buffer 62, the third surfaces 60c of the second buffer 62 are deformed to bulge. Therefore, since the second cover 72 includes the surrounding portion 70a to surround and cover the third surfaces 60c of the second buffer 62, scattering of fragments caused by deformation of the third surfaces 60c of the second buffer 62 can be reduced or prevented by the surrounding portion 70a. The first cover 71 and the third cover 73 also have the same advantage.

The surrounding portion 70a is configured to surround and cover the entire peripheries of the third surfaces 60c of the buffer 60. Accordingly, the surrounding portion 70a surrounds and covers the entire peripheries of the third surfaces 60c, and thus scattering of fragments caused by deformation of the third surfaces 60c of the buffer 60 can be further reduced or prevented.

The surrounding portion 70a is configured to cover more than half of the third surfaces 60c of the second buffer 62, but not to cover all of the third surfaces 60c of the second buffer 62, in the relative movement direction between the first arm 22 and the rotating base 21. Accordingly, a relatively large portion of the third surfaces 60c of the second buffer 62 is covered with the surrounding portion 70a, and thus scattering of fragments caused by deformation of the third surfaces 60c of the second buffer 62 can be reduced or prevented. The first cover 71 and the third cover 73 also have the same advantage.

The second cover 72 includes the mount 70b attached to the first arm 22. Accordingly, the second cover 72 can be easily attached to the first arm 22 by the mount 70b. The first cover 71 and the third cover 73 also have the same advantage.

The second buffer 62 includes a rubber member or a resin member. The second cover 72 includes a sheet metal member. Accordingly, the second buffer 62 includes a relatively soft rubber member resin member, and thus the second buffer 62 reduces the impact caused by a direct collision between the protrusion 22a of the first arm 22 and the protrusion 21b of the rotating base 21.

Furthermore, the second cover 72 is a sheet metal member, and thus the second cover 72 is easily deformed together with the second buffer 62. This can reduce or prevent damage to the protrusion 21b of the rotating base 21 that comes into contact with the second cover 72 due to the second cover 72 being too hard. The first cover 71 and the third cover 73 also have the same advantage.

The second cover 72 includes a folded sheet metal member. Accordingly, the second cover 72 can be easily formed of a sheet metal member. The first cover 71 and the third cover 73 also have the same advantage.

The second buffer 62 is on the first arm 22. The second cover 72 is on the protrusion 22a of the first arm 22 to cover the second buffer 62. Accordingly, the second buffer 62 is covered with the second cover 72 in advance, and thus scattering of fragments of the second buffer 62 can be reliably reduced or prevented when the protrusion 22a of the first arm 22 and the protrusion 21b of the rotating base 21 approach each other. The first cover 71 and the third cover 73 also have the same advantage.

The robot 100 includes the base 10 and the rotating base 21 configured to rotate relative to the base 10. Excessive rotation of the rotating base 21 may cause contact between the protrusion 21a of the base 10 and the first buffer 61, causing fragments of the first buffer 61 to scatter. Thus, disposing the first cover 71 so as to cover the first buffer 61 is particularly effective in reducing or preventing scattering of fragments of the first buffer 61.

The robot 100 includes the robot arm 20 including the rotating base 21 and the first arm 22 connected to the rotating base 21. Excessive rotation of the first arm 22 may cause contact between the protrusion 21a of the rotating base 21 and the second buffer 62, causing fragments of the second buffer 62 to scatter. Thus, disposing the second cover 72 so as to cover the second buffer 62 disposed on the first arm 22 is particularly effective in reducing or preventing scattering of fragments of the second buffer 62.

The robot 100 includes the robot arm 20 including the first arm 22 and the second arm 23 configured to rotate relative to the first arm 22. Excessive relative rotation of the first arm 22 and the second arm 23 may cause contact between the protrusion 23a of the second arm 23 and the third buffer 63, causing fragments of the third buffer 63 to scatter. Thus, disposing the third cover 73 so as to cover the third buffer 63 is particularly effective in reducing or preventing scattering of fragments of the third buffer 63.

### Modified Examples

The embodiment disclosed this time must be considered as illustrative in all points and not restrictive. The scope of the present disclosure is not shown by the above description of the embodiment but by the scope of claims for patent, and all modifications (modified examples) within the meaning and scope equivalent to the scope of claims for patent are further included.

For example, while the example in which the first buffer 61 and the first cover 71 are disposed on the base 10 has been shown in the aforementioned embodiment, the present disclosure is not limited to this. In the present disclosure, the first buffer 61 and the first cover 71 may be disposed on the protrusion 21a of the rotating base 21.

While the example in which the second buffer 62 and the second cover 72 are disposed on the first arm 22 has been shown in the aforementioned embodiment, the present disclosure is not limited to this. In the present disclosure, the second buffer 62 and the second cover 72 may be disposed on the protrusion 21b of the rotating base 21.

While the example in which the third buffer 63 and the third cover 73 are disposed on the first arm 22 has been shown in the aforementioned embodiment, the present disclosure is not limited to this. In the present disclosure, the third buffer 63 and the third cover 73 may be disposed on the protrusion 23a of the second arm 23.

While the example in which the first arm 22, for example, is applied as the first member according to the present disclosure, and the second arm 23, for example, is applied as the second member according to the present disclosure has been shown in the aforementioned embodiment, the present disclosure is not limited to this. For example, the robot arm 20 may be applied as the first member according to the present disclosure, and a traveling shaft for translating the robot arm 20 may be applied as the second member according to the present disclosure. In such a case, a buffer 60 may be disposed at a portion at which the traveling axis and the robot arm 20 contact each other, and a cover 70 may be disposed so as to cover the buffer 60.

While the example in which the cover 70 does not cover the first surface 60a of the buffer 60 has been shown in the aforementioned embodiment, the present disclosure is not limited to this. For example, the cover 70 may cover the first surface 60a of the buffer 60.

While the example in which the surrounding portion 70a of the cover 70 surrounds the entire peripheries of the third surfaces 60c of the buffer 60 has been shown in the aforementioned embodiment, the present disclosure is not limited to this. For example, the surrounding portion 70a of the cover 70 may cover a portion of the entire peripheries of the third surfaces 60c of the buffer 60.

While the example in which the buffer 60 has a rectangular parallelepiped shape has been shown in the aforementioned embodiment, the present disclosure is not limited to this. For example, the buffer 60 may have a solid cylindrical shape. When the buffer 60 has a solid cylindrical shape, the surrounding portion 70a of the cover 70 has a hollow cylindrical shape.

While the example in which the buffer 60 and the cover 70 are fixed to the first arm 22 or the like by the threaded portions 80 and 81 such as screws, respectively, has been shown in the aforementioned embodiment, the present disclosure is not limited to this. For example, the buffer 60 and the cover 70 may be fixed to the first arm 22 or the like by an adhesive.

While the example in which the buffer 60 includes a rubber member or a resin member has been shown in the aforementioned embodiment, the present disclosure is not limited to this. For example, the buffer 60 may include a member other than a rubber member and a resin member.

While the example in which the cover 70 is formed of a sheet metal member has been shown in the aforementioned embodiment, the present disclosure is not limited to this. For example, the cover 70 may be formed of a relatively soft metal member other than a sheet metal member.

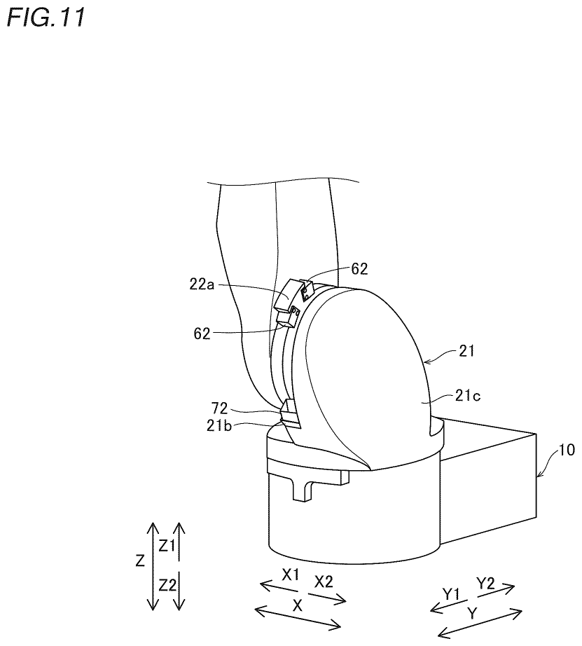

While the example in which the buffer 60 is covered with the cover 70 before the rotating base 21 or the like and the first arm 22 or the like contact each other has been shown in the aforementioned embodiment, the present disclosure is not limited to this. For example, as shown in FIG. 11, the second buffer 62 may be disposed on the first arm 22, and the second cover 72 may be disposed on the rotating base 21. When the first arm 22 rotates relative to the rotating base 21 and the protrusion 22a of the first arm 22 approaches the protrusion 21b of the rotating base 21, the cover 70 may cover the buffer 60. Thus, the second buffer 62 is exposed except when the rotating base 21 and the first arm 22 approach each other, and thus a user can easily visually recognize deterioration of the second buffer 62.

While the example in which the robot 100 is a 6-axis vertical articulated robot has been shown in the aforementioned embodiment, the present disclosure is not limited to this. The present disclosure can also be applied to vertical articulated robots having the number of axes other than six or horizontal articulated robots.

### Aspects

It will be appreciated by those skilled in the art that the exemplary embodiments described above are specific examples of the following aspects.

### (Item 1)

A robot comprising:
a first member;
a second member configured to move relative to the first member;
a restrictor including a first portion that is a portion of the first member and a second portion that is a portion of the second member to restrict relative movement between the first member and the second member;
a buffer on at least one of the first member and the second member and between the first portion and the second portion; and
a cover on at least one of the first member and the second member to cover the buffer.
   (item 2)
The robot according to item 1, wherein the cover is configured to surround and cover a portion of the buffer other than a portion facing at least one of the first portion and the second portion when the first portion and the second portion approach each other.

### (Item 3)

The robot according to item 2, wherein
the buffer includes:
   a first surface contacting the restrictor;
   a second surface on a side opposite to the first surface in a relative movement direction between the first member and the second member; and
   a third surface connecting the first surface to the second surface; and
the cover includes a surrounding portion to surround and cover the third surface of the buffer.

### (Item 4)

The robot according to item 3, wherein the surrounding portion is configured to surround and cover an entire periphery of the third surface of the buffer.

### (Item 5)

The robot according to item 4, wherein the surrounding portion is configured to cover more than half of the third surface of the buffer, but not to cover all of the third surface of the buffer, in the relative movement direction between the first member and the second member.

### (Item 6)

The robot according to any one of items 1 to 5, wherein the cover includes a mount attached to at least one of the first member and the second member.

### (Item 7)

The robot according to any one of items 1 to 6, wherein
the buffer includes a rubber member or a resin member; and
the cover includes a sheet metal member.

### (Item 8)

The robot according to item 7, wherein the cover includes a folded sheet metal member.

### (Item 9)

The robot according to any one of items 1 to 8, wherein
the buffer is on one of the first portion and the second portion; and
the cover is on one of the first member and the second member to cover the buffer.

### (Item 10)

The robot according to any one of items 1 to 9, wherein
the buffer is on either the first portion or the second portion; and
the cover is on either the second portion or the first portion.

### (Item 11)

The robot according to any one of items 1 to 10, comprising:
a base; and
a rotating base configured to rotate relative to the base; wherein
the first member includes the base; and
the second member includes the rotating base.

### (Item 12)

The robot according to any one of items 1 to 11, comprising:
a robot arm including a rotating base and an arm connected to the rotating base; wherein
the first member includes the arm; and
the second member includes the rotating base.

### (Item 13)

The robot according to any one of items 1 to 12, comprising:
a robot arm including a first arm and a second arm configured to rotate relative to the first arm; wherein
the first member includes the first arm; and
the second member includes the second arm.

1. A robot comprising:
a first member;
a second member configured to move relative to the first member;
a restrictor including a first portion that is a portion of the first member and a second portion that is a portion of the second member to restrict relative movement between the first member and the second member;
a buffer on at least one of the first member and the second member and between the first portion and the second portion; and
a cover on at least one of the first member and the second member to cover the buffer.

2. The robot according to claim 1, wherein the cover is configured to surround and cover a portion of the buffer other than a portion facing at least one of the first portion and the second portion when the first portion and the second portion approach each other.

3. The robot according to claim 2, wherein the buffer includes:
a first surface contacting the restrictor;
a second surface on a side opposite to the first surface in a relative movement direction between the first member and the second member; and
a third surface connecting the first surface to the second surface; and
the cover includes a surrounding portion to surround and cover the third surface of the buffer.

4. The robot according to claim 3, wherein the surrounding portion is configured to surround and cover an entire periphery of the third surface of the buffer.

5. The robot according to claim 4, wherein the surrounding portion is configured to cover more than half of the third surface of the buffer, but not to cover all of the third surface of the buffer, in the relative movement direction between the first member and the second member.

6. The robot according to claim 1, wherein the cover includes a mount attached to at least one of the first member and the second member.

7. The robot according to claim 1, wherein
the buffer includes a rubber member or a resin member; and
the cover includes a sheet metal member.

8. The robot according to claim 7, wherein the cover includes a folded sheet metal member.

9. The robot according to claim 1, wherein
the buffer is on one of the first portion and the second portion; and
the cover is on one of the first member and the second member to cover the buffer.

10. The robot according to claim 1, wherein
the buffer is on either the first portion or the second portion; and
the cover is on either the second portion or the first portion.

11. The robot according to claim 1, comprising:
a base; and
a rotating base configured to rotate relative to the base; wherein
the first member includes the base; and
the second member includes the rotating base.

12. The robot according to claim 1, comprising:
a robot arm including a rotating base and an arm connected to the rotating base; wherein
the first member includes the arm; and
the second member includes the rotating base.

13. The robot according to claim 1, comprising:
a robot arm including a first arm and a second arm configured to rotate relative to the first arm; wherein
the first member includes the first arm; and
the second member includes the second arm.
